(19) United States
(12) Patent Application Publication
(10) Pub. No.: US 2026/0105126 A1
(43) Pub. Date: Apr. 16, 2026

(54) TARGET VALUE SETTING DEVICE

(71) Applicant: NTT DOCOMO, INC., Tokyo (JP)

(72) Inventors: Takafumi YAMAUCHI, Chiyoda-ku (JP); Yuuki YAMADA, Chiyoda-ku (JP); Kengo MIEDA, Chiyoda-ku (JP); Satoshi HIYAMA, Chiyoda-ku (JP)

(73) Assignee: NTT DOCOMO, INC., Tokyo (JP)

(21) Appl. No.: 18/871,925

(22) PCT Filed: Jul. 5, 2023
(86) PCT No.: PCT/JP2023/024991

§ 371 Date: Dec. 5, 2024

(30) Foreign Application Priority Data
Jul. 22, 2022 (JP) 2022-117219

(51) Int. Cl. G06F 18/23211; G06F 3/01

(52) U.S. Cl. CPC G06F 18/23211; G06F 3/011

(57) ABSTRACT

To provide a target value setting device capable of setting an appropriate target value for each individual.

In a target value setting device 100, a target value calculation unit 103 calculates statistical information (for example, variance and an average value) of behavior of one user over a predetermined period of time. The target value calculation unit 103 then calculates a target value for the behavior of the one user on the basis of the statistical information. A result notification unit 104 notifies the one user of the target value. This target value is set on the basis of the statistical information so that a load is higher than normal behavior of one user or healthier than normal.

### TECHNICAL FIELD

The present invention relates to a target value setting device that sets a target value for a user's behavior.

### BACKGROUND ART

Patent Literature 1 discloses that, in order to set a target value which is appropriate in terms of health, a data evaluation unit stores target data which is appropriate in terms of health, for example, reference ranges of appropriate weight based on gender and height, a user inputs his/her weight, gender, and target value data, for example, a target weight, into a data input unit, and a data output unit notifies the user that the target weight is not appropriate when the target weight is outside the reference range.

### CITATION LIST

### Patent Literature

[Patent Literature 1] Japanese Unexamined Patent Publication No. H11-306257

### SUMMARY OF INVENTION

### Technical Problem

For behavior change, simply presenting the health risk of not changing behavior is ineffective, and it is important to present specific target values for lifestyle habits to be improved. It is important that these target values are neither too high nor low for each individual and are of moderate difficulty. Setting the target value to be high leads to the minimum level of satisfaction, and thus it is not likely to obtain satisfaction. On the other hand, setting the target value to be low or not setting a specific target value results in lower performance than in a case where the target is high.

The disclosure in Patent Literature 1 does not present a target value for a user's behavior, and is therefore not appropriate as a target value for encouraging the user to change his/her behavior. In general, determining a target value uniquely for the user's behavior can be considered, but the target value may be high or conversely low depending on the person, and may not be an appropriate target value.

Consequently, in order to solve the above-described problems, an object of the present invention is to provide a target value setting device capable of setting an appropriate target value for each individual.

### Solution to Problem

According to the present invention, there is provided a target value setting device including: a statistical information calculation unit configured to calculate statistical information on behavior of one user and/or another user over a predetermined period of time; a target value calculation unit configured to calculate a target value of the behavior of the one user on the basis of the statistical information; and a notification unit configured to notify the one user of the target value, wherein the target value is set on the basis of the statistical information so that a load is moderately higher than normal behavior of the one user or healthier than normal.

### Advantageous Effects of Invention

According to the present invention, it is possible to set an appropriate target value for each individual.

### BRIEF DESCRIPTION OF DRAWINGS

FIG. 1 is a diagram illustrating a system configuration including a target value setting device 100 of the present disclosure.

FIG. 2 is a functional block diagram illustrating a functional configuration of the target value setting device 100.

FIG. 3 is a diagram illustrating user behavior information stored in a data storage unit 102.

FIG. 4 is a diagram illustrating a distribution of the number of steps taken by a user A.

FIG. 5 is a flowchart illustrating the overall operation of the target value setting device 100.

FIG. 6 is a flowchart illustrating detailed processing for calculating a target value in process S103.

FIG. 7 is a detailed flowchart of process S203.

FIG. 8 is a diagram illustrating that the target value is set to an average ±1τ in accordance with the direction of improvement.

FIG. 9 is a diagram illustrating an example of a hardware configuration of the target value setting device 100 according to an embodiment of the present disclosure.

### DESCRIPTION OF EMBODIMENTS

An embodiment of the present disclosure will be described with reference to the accompanying drawings. The same components are denoted, if possible, by the same reference numerals and signs, and thus description thereof will not be repeated.

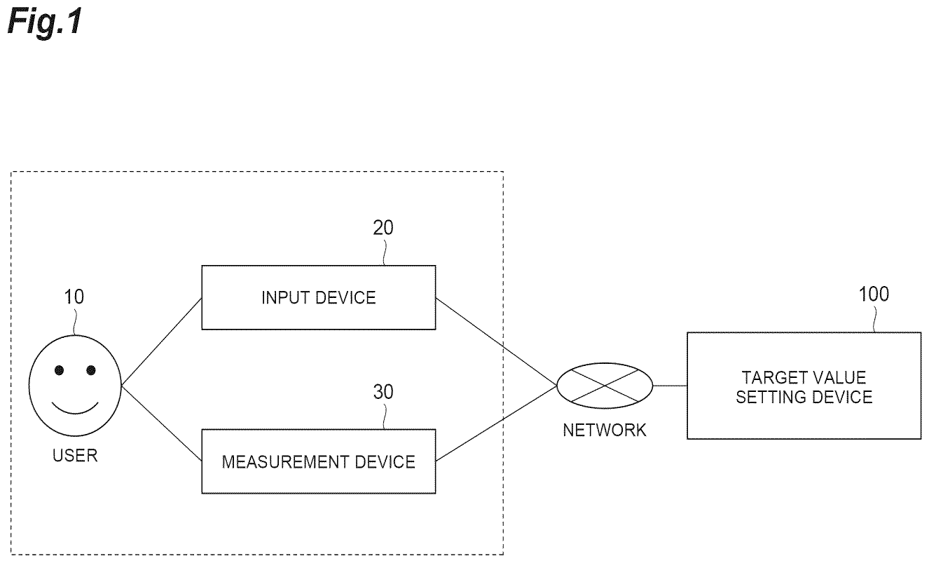

FIG. 1 is a diagram illustrating a system configuration including a target value setting device 100 of the present disclosure. As shown in the drawing, a user 10 holds an input device 20 and a measurement device 30. The target value setting device 100 transmits user behavior measured in the measurement device 30 to the target value setting device 100. The target value setting device 100 calculates a target value for a user on the basis of the user's behavior and notifies the user of the calculated target value. The measurement device 30 has a sensor function capable of measuring the user's behavior, such as a gyro sensor or a GPS sensor.

The user's behavior may include the number of steps taken, the amount of sleep time (which may be bedtime and wake-up time), the frequency of going out, meal times, calorie intake, the number of times and duration of communication with others, and the like, and the number of steps taken, the amount of sleep time, and the frequency of going out are measured using a gyro sensor, a GPS sensor, or the like. The amount of sleep time is calculated on the basis of the sleep state, and the sleep state is determined on the basis of the time during which the input device 20 and the measurement device 30 are not operated. The meal times and calorie intake are determined on the basis of the user's input to the input device 20. For the number of times and duration of communication with others, in a case where the input device 20 or the like has a calling function or a communication function, the communication frequency or communication time are measured by the measurement device 30.

The input device 20 has a display unit and a speaker for inputting a target value from the target value setting device 100, notifying the user of the target value, and suggesting user behavior based on the target value. The functions of the input device 20 and the measurement device 30 are realized by a portable terminal such as a smartphone.

The target value setting device 100 of the present disclosure includes a risk calculation function for calculating a user's health risk and a transmission function of transmitting a message for behavior change to the user.

The risk calculation function can ascertain the user's behavior (such as the number of steps taken or the amount of sleep time) on the basis of the user's operations on the input device 20 and the measurement device 30, and calculate the health risk on the basis of that behavior. The health risk may be a risk of lifestyle-related disease or a risk of needing nursing care that can be inferred from the user's behavior, or may be any other health risk. In addition, the transmission function transmits the health risk to the user. Information on the health risk includes a message for behavior change. This message includes a target value defined for each user. The message for behavior change is, for example, a message that encourages the user to change his or her behavior in accordance with the user's health risk determined on the basis of the user's behavior history. In the present disclosure, the transmission function transmits a message such as, for example, “Let's walk to reduce the risk” along with its target value.

Meanwhile, these transmission function and risk calculation function do not have to be included in the target value setting device. These may be present in a separate device as a health risk calculation device.

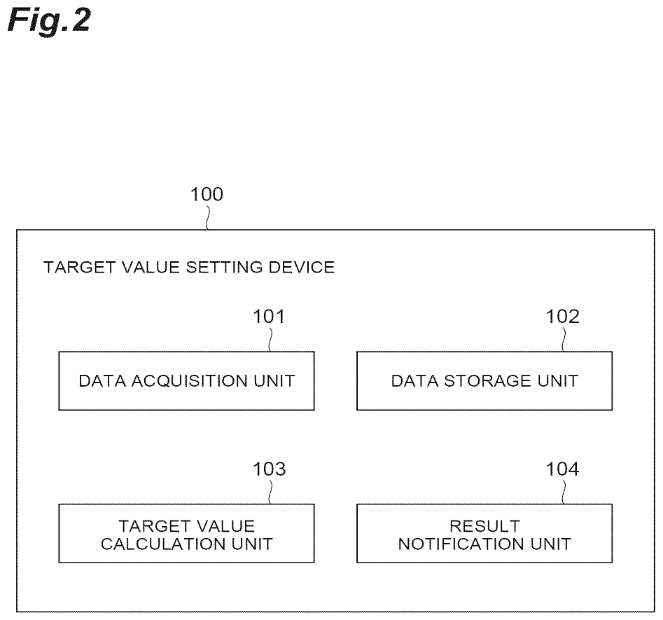

FIG. 2 is a functional block diagram illustrating a functional configuration of the target value setting device 100. The target value setting device 100 is configured to include a data acquisition unit 101, a data storage unit 102, a target value calculation unit 103, and a result notification unit 104.

The data acquisition unit 101 is a part that acquires user behavior information from the measurement device 30 and stores the user behavior information in the data storage unit 102.

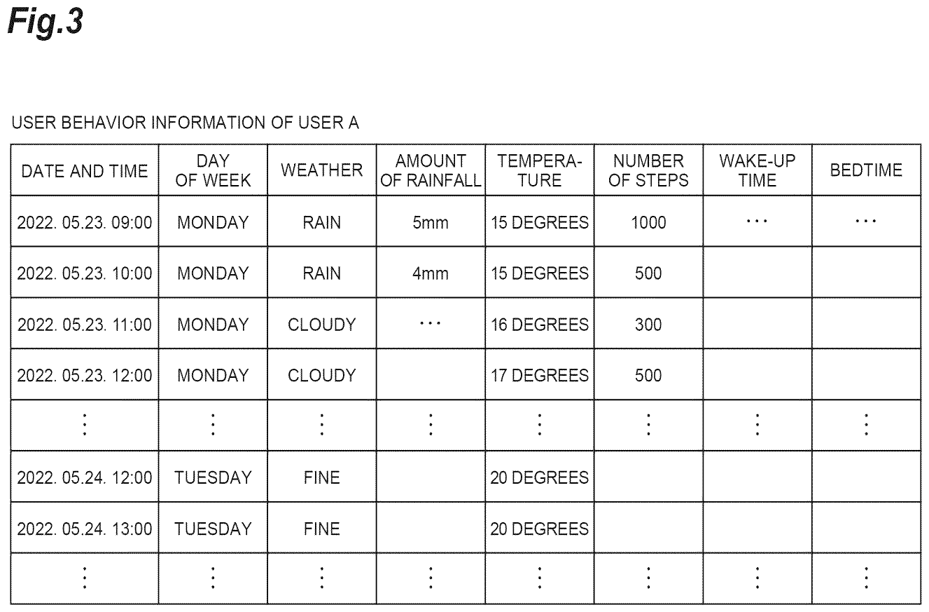

The data storage unit 102 is a part that stores the user behavior information. The user behavior information is information indicating the user's behavior, and is information indicating, for example, the number of steps taken, the amount of sleep time (which may be bedtime and wake-up time), the frequency of going out, meal times, calorie intake, the number of times and duration of communication with others, and the like for each user. As shown in FIG. 3, the number of steps taken is associated with each time slot. In FIG. 3, information such as the day of the week, weather, and temperature is further associated therewith. Meanwhile, the wake-up time and bedtime may be stored for each day, and the amount of sleep time may be associated therewith.

The target value calculation unit 103 is a part that calculates a target value for each user on the basis of the user behavior information stored in the data storage unit 102. The details thereof will be described later.

The result notification unit 104 is a part that transmits the target value calculated by the target value calculation unit 103 to the input device 20.

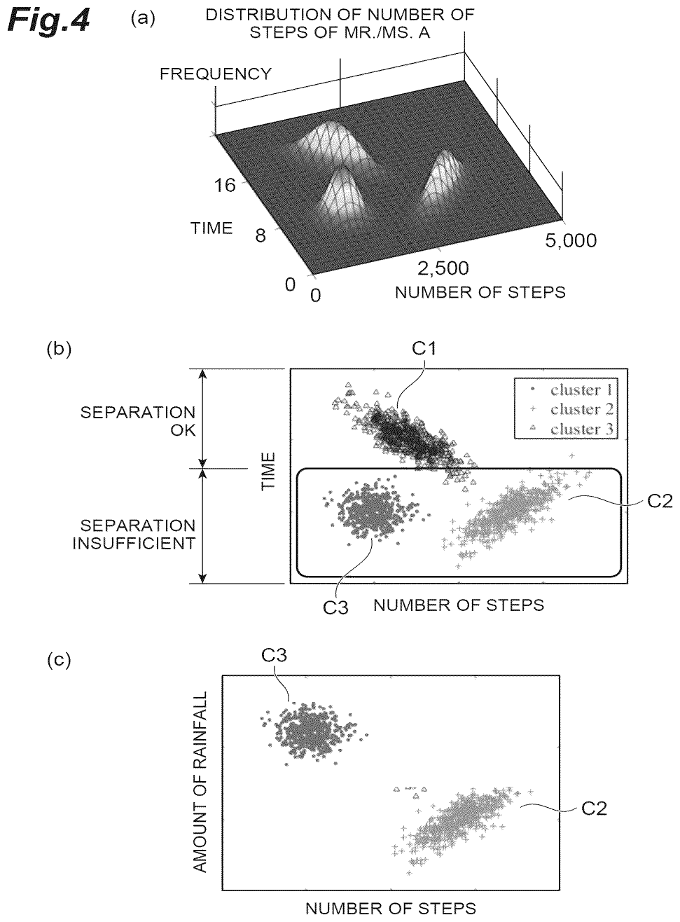

Next, a target value calculation process performed by the target value calculation unit 103 will be described. FIG. 4 is a diagram illustrating the frequency of user behavior information. In the present disclosure, an example of user behavior is, but is not limited to, the number of steps taken. In addition to the number of steps taken, the user behavior may be, as described above, the amount of sleep time or the frequency of going out.

FIG. 4(a) is a distribution diagram illustrating a distribution of the number of steps taken of a user A. This drawing is a distribution diagram consisting of the time slot, the number of steps taken, and the frequency of steps. The frequency here indicates the number of times or probability that each number of steps taken separated into predetermined units has been reached in the past. As shown in FIG. 4(a), since user behavior such as the number of steps taken varies depending on the time of day or other circumstances, it is desirable to set a target value for each situation in which the user is placed.

The data acquisition unit 101 acquires the feature amount of any given situation (such as time, temperature, or amount of rainfall) and the number of steps taken (lifestyle habits to be improved) for each predetermined unit of the situation (feature amount), and the target value calculation unit 103 generates a distribution diagram shown in FIG. 4(a). Meanwhile, the number of any given situations (feature amounts) may be one or plural.

FIG. 4(b) is a distribution diagram with the horizontal axis representing the number of steps taken (lifestyle habit to be improved) and the vertical axis representing any given situation (feature amount). This drawing is a plan view of the distribution diagram shown in FIG. 4(a). The target value calculation unit 103 performs clustering on this distribution diagram using a Gaussian mixture model. The purpose of clustering is to ascertain a difference in the distribution of the number of steps taken (lifestyle habits to be improved) for each situation and to set a target value according to the situation. Thus, it is desirable to extract and ascertain situations in which the distribution of the number of steps taken (lifestyle habits to be improved) is as different as possible rather than situations in which the distribution is similar.

The target value calculation unit 103 performs clustering using an information criterion such as an Akaike information criterion (AIC) or a Bayesian information criterion (BIC). As the value of the information criterion such as an AIC becomes smaller, the suitability of a model becomes better, and thus the number of clusters which is considered to be optimal is determined based on the relationship between the number of clusters and the information criterion.

From the assumption that “data belonging to a certain cluster is Gaussian distributed near the center of gravity of the cluster,” it is possible to calculate the likelihood on the basis of the actual distribution (in a case where the assumption is correct, how probable is the actual distribution, that is, how close is it to a Gaussian distribution), and in the present disclosure, this likelihood can be used in a case where the information criterion is calculated.

In addition, when the information criterion such as an AIC is calculated, the information criterion is calculated on the basis of the likelihood calculated without taking into account the number of steps taken, that is, using only the situation (feature amount) other than the number of steps taken, for the clustering result performed using the number of steps taken (lifestyle habit to be improved) and the situation (feature amount). This is to extract and ascertain situations in which the distribution of the number of steps taken (lifestyle habit to be improved) is as different as possible, and to evaluate the suitability of clustering based only on the situation (feature amount).

FIG. 4(b) shows that the target value calculation unit 103 determines that the clustering for two lower distributions is insufficient, further adds a situation (feature amount), and performs clustering. The target value calculation unit 103 determines whether the separation is insufficient using an AIC or a BIC. The target value calculation unit 103 calculates an information criterion for each cluster C using user behavior information, and repeats clustering the calculated value is minimized or until the value of the information criterion is no longer expected to decrease by more than a predetermined value compared to before the situation (feature amount) was added.

Meanwhile, whether the clustering is sufficient may be determined based on whether the information criterion is smaller than a predetermined criterion value, or whether the clustering is sufficient may be determined by comparing whether the information criterion has become smaller or larger compared to before the feature amount was added or reduced.

FIG. 4(c) is a distribution diagram in which the number of steps taken is further clustered using the amount of rainfall as a situation (feature amount) from the distribution of the number of steps taken in which the separation in FIG. 4(b) is determined to be insufficient. As shown in the drawing, this shows that the separation here has been performed to a degree that can be determined to be sufficient.

As shown in FIG. 4, the user behavior information is separated into clusters C1 to C3, and the average number of steps taken and the like are calculated for each cluster. In the cluster C1, the average and variance of number of steps taken in a certain time slot are calculated. In the clusters C2 and C3, the average and variance of the number of steps taken are calculated for each amount of rainfall without considering the time slot. The cluster C3 shows the distribution in a case where the amount of rainfall is high (the amount of rainfall is equal to or greater than a predetermined value), and the cluster C2 shows the distribution in a case where the amount of rainfall is low (the amount of rainfall is less than the predetermined value).

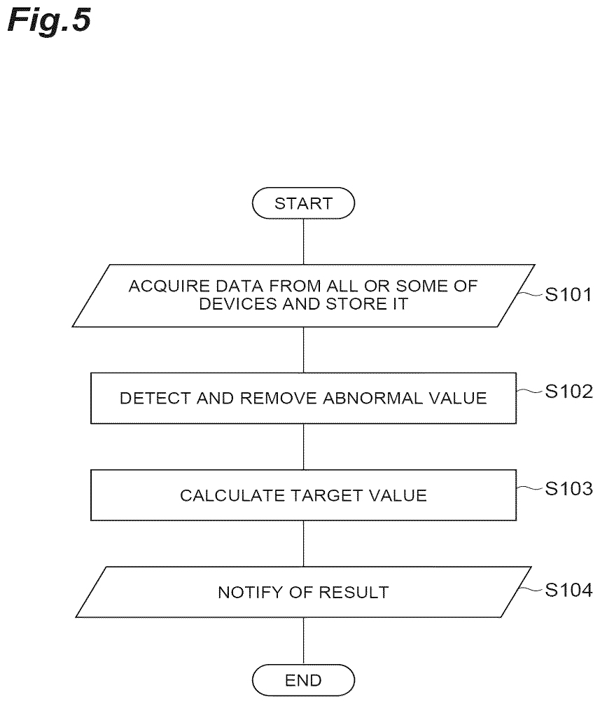

Next, the operation of the target value setting device 100 of the present disclosure will be described. FIG. 5 is a flowchart illustrating the overall operation of the target value setting device 100. The data acquisition unit 101 acquires data from all or some of the devices of one user and stores the data in the data storage unit 102 (S101). Each device here is the measurement device 30 for measuring each lifestyle habit item (such as the number of steps taken). In the present disclosure, one measurement device 30 is shown, but there may be a plurality of measurement devices, and one measurement device 30 may measure a plurality of lifestyle habit items (such as the number of steps taken and the amount of sleep time).

The target value calculation unit 103 detects abnormal values of lifestyle habit items and removes them (S102). For example, a lifestyle habit item with extremely large or small values compared to other measured lifestyle habit items may be determined as an abnormal value.

The target value calculation unit 103 calculates the target values for lifestyle habit items of one user (S103). The result notification unit 104 notifies the one user of the target values (S104).

As will be described later, the target value calculation unit 103 may set a target value for each feature amount indicated by the situation in which the user is placed. In that case, the result notification unit 104 notifies the user of a target value according to the situation (feature amount) in which the user is placed. For example, the user's behavior may change depending on the weather, the time slot, the day of the week, or the like, and the target value changes in accordance therewith. The result notification unit 104 should notify the user of the target value according to the situation in which the user is placed at the time when the notification is intended.

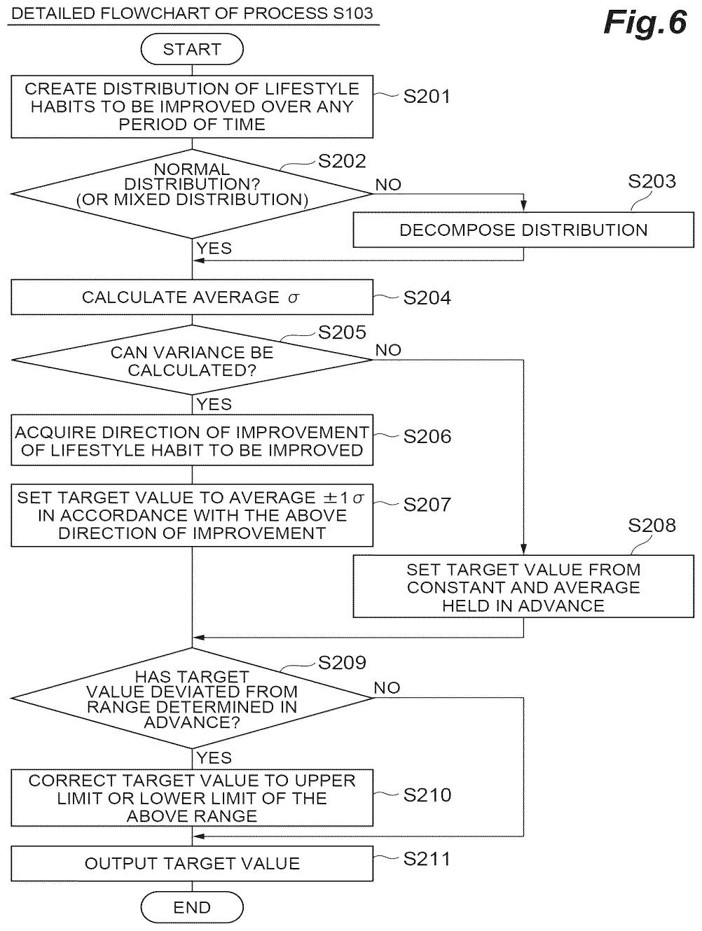

Next, the detailed processing for calculating the target value process in S103 will be described. FIG. 6 is a flowchart illustrating the processing. The target value calculation unit 103 creates a distribution on the basis of user behavior information for any given period among user behavior information on a lifestyle habit to be improved (S201). In the present disclosure, for example, the lifestyle habit to be improved is the number of steps taken. In addition, the distribution is shown in FIG. 4. The distribution shown in FIG. 4(a) is shown three-dimensionally with two situations (feature amounts) and one lifestyle habit, but in a case where there is one situation (feature amount), the distribution will be shown two-dimensionally.

The target value calculation unit 103 determines whether the distribution is a normal distribution or a mixed distribution (S202). In the present disclosure, the normal distribution means that the lifestyle habit to be improved is not constituted by a plurality of distributions and does not require separation based on clustering.

In addition, in a case where the distribution is a mixed distribution, the target value calculation unit 103 decomposes the distribution into several normal distributions (S203). This makes it possible to ascertain which behaviors at what timing constitute each distribution. Meanwhile, in a case where there are a plurality of normal distributions, processes S204 to S211 to be described below are performed for each of them.

The target value calculation unit 103 calculates the average value and variance of the user behavior of the lifestyle habits (the number of steps taken) to be improved for one or each normal distribution (S204).

The target value calculation unit 103 determines whether the variance has been calculated (S205). In a case where the variance has been calculated (S205: YES), the target value calculation unit 103 acquires the direction of improvement of the lifestyle habit to be improved (S206). The direction of improvement of the lifestyle habit indicates the direction in which the user behavior reduces the health risk of the user. For example, in a case where the number of steps taken is insufficient, it is a direction in which a predetermined value such as the variance is added (plus) to the average value. Conversely, the bedtime is improved in a negative (earlier) direction. In this way, a predetermined direction may be acquired in accordance with the lifestyle habits.

The acquisition of the direction of improvement also includes acquiring a message for that improvement. For example, a message such as “Hello! Your health risk for xx is xx %. Especially in your case, you may be able to reduce the risk by improving the number of steps you take. First, try to aim to walk xx steps a day.” may be acquired. The “health risk for xx” in this message is, for example, the “health risk for frailty.” These health risks are calculated from the terminal operation history. These processes are well known, and thus will not be described here.

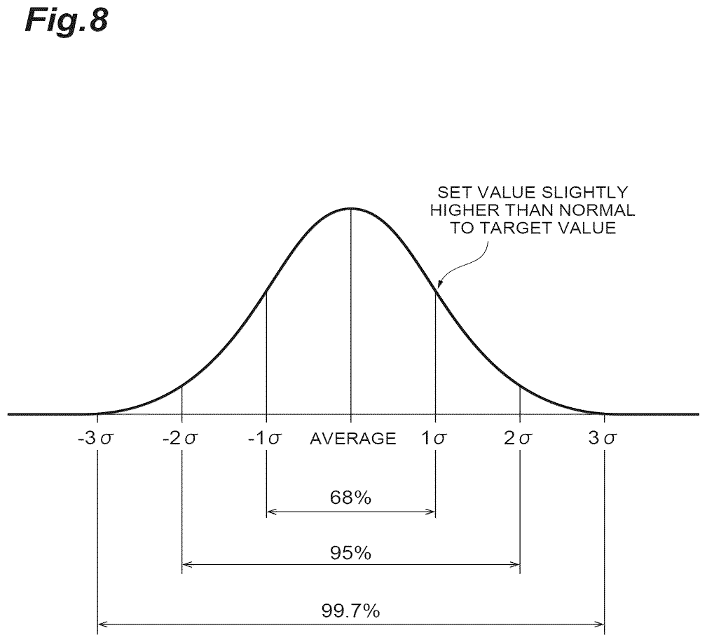

The target value calculation unit 103 sets the target value to the average ±1σ in accordance with the above direction of improvement (S207). A specific example is shown in FIG. 8. FIG. 8 is a diagram illustrating a normal distribution, where the average value+1σ indicates a value slightly higher than the average. This slightly higher value imposes a load on the user's behavior to maintain a moderate level of health.

On the other hand, in process S205, in a case where the variance cannot be calculated (or the variance is equal to or less than a predetermined value), the target value calculation unit 103 sets the target value from a constant and an average held in advance (S208). A case where the variance cannot be calculated is, for example, a case where there is only one day's worth of user's behavior information.

The target value calculation unit 103 determines whether the target value has deviated from a range determined in advance (S209). In a case where it deviates (S209: YES), the target value calculation unit 103 corrects the target value to the upper limit or lower limit of the above range (S210). A range deviating from the above range determined in advance indicates a range that is obviously inappropriate as a target value, which is set in advance for the target in question.

The target value calculation unit 103 outputs the target value (S211). The output here means outputting the target value and a message including it to the result notification unit 104.

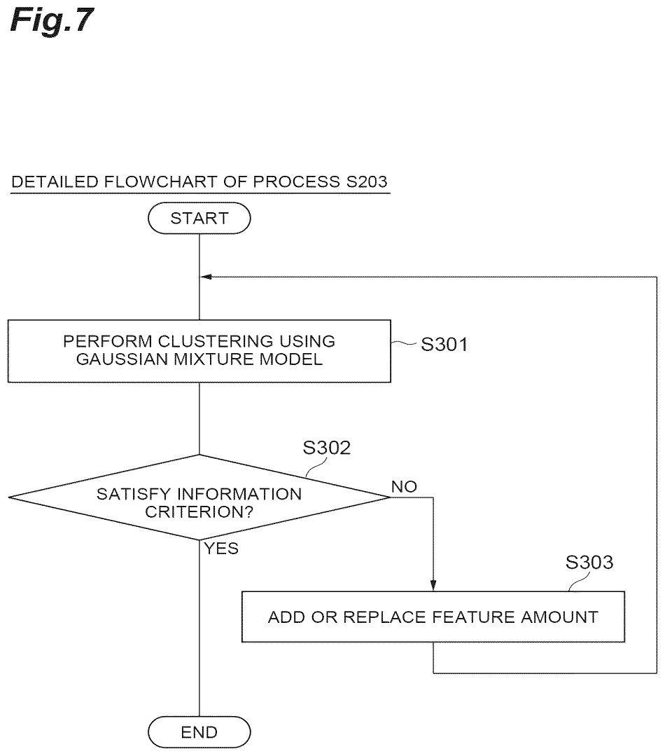

Next, the decomposition of the mixed distribution in process S203 will be described. FIG. 7 is a detailed flowchart of process S203. The target value calculation unit 103 performs clustering using a Gaussian mixture model on the distribution determined to be a mixed distribution (S301). Meanwhile, this is, of course, not limited to clustering using a Gaussian mixture model, and other methods may be used.

The target value calculation unit 103 determines whether the user behavior information included in each distribution as a result of the clustering satisfies an information criterion (S302). As described above, the AIC or BIC is used as the information criterion. For example, in a case where the AIC is used, the number of parameters used in the AIC is the number of feature amounts used when the clustering is performed.

The target value calculation unit 103 calculates the average and variance using the user behavior information of each distribution that satisfies the information criterion.

In a case where the information criterion is not satisfied, the target value calculation unit 103 attempts further clustering by adding a feature amount (S303). The feature amount to be added is determined according to a priority order determined in advance. In the present disclosure, each feature amount is added in the order of priority such as time slot, amount of rainfall, weather, and the like. This priority order is assumed to be determined in advance.

The target value calculation unit 103 performs clustering while adding a feature amount until the information criterion is satisfied.

In the present disclosure, instead of adding a feature amount, the feature amount may be replaced. The target value calculation unit 103 may perform clustering by excluding a feature amount that does not contribute to clustering and adding another new feature amount. The following methods are considered as a method of excluding a feature amount that does not contribute to clustering.

For example, when clustering is performed by removing one of the feature amounts (such as time or amount of rainfall) in turn, the feature amount that has the least deterioration in the information criterion such as an AIC is removed. As the value of the information criterion such as an AIC becomes smaller, the suitability becomes better. Thus, in the case of addition, a feature amount whose information criterion is equal to or greater than a predetermined value may be removed. In addition, in the case of addition, a feature amount whose information criterion does not deteriorate (or whose information criterion is equal to or greater than a predetermined value) is, in other words, a feature amount that can be dispensed with, and such a feature amount is a feature amount that does not contribute to clustering.

In addition, when clustering is performed, and then any one of the feature amounts and the lifestyle habit to be improved item are plotted on two axes, a feature amount with the largest overlapping portion (which can be calculated from the probability density of the distribution) between the clusters is removed. A distribution based on feature amounts with a large overlapping portion can be considered to have no ability to separate the clusters.

Next, the operation and effect of the target value setting device 100 of the present disclosure will be described. In the target value setting device 100 of the present disclosure, the target value calculation unit 103 calculates statistical information (for example, variance and an average value) on the behavior of one user over a predetermined period of time. The target value calculation unit 103 then calculates a target value for the behavior of the one user on the basis of the statistical information. The result notification unit 104 notifies the one user of the target value. This target value is set on the basis of the statistical information so that a load is higher than normal behavior of the one user or healthier than normal.

Such a configuration makes it possible to encourage behavior change aimed at maintaining and improving health by setting appropriate target values for each individual.

Risk presentation alone is not effective in changing the behavior of a user, and specific target values for lifestyle habits to be improved are important.

Setting the target to be high leads to the minimum level of satisfaction, and thus it is not likely to obtain satisfaction. On the other hand, setting the target to be low or not setting a specific target results in lower performance than in a case where the target is high. The target can be quite forcing and can be a source of pressure. Thus, it is important that the target value is neither too high nor low and is of moderate difficulty. In the present disclosure, the target value is on the basis of the statistical information so that a load is set to be moderately high.

Setting a load on the amount of sleep time to be high means setting the amount of healthier sleep time. The amount of sleep time is set to be neither too high nor too low so that the amount of sleep time is set to be long in a case where it is short, and that conversely, the amount of sleep time is set to be short in a case where it is long. In the present disclosure, the target value is set so as to promote healthier behavior than normal, but the target value is set not to be too easy. For example, as a target value for the amount of sleep time, setting the bedtime or wake-up time to a moderately difficult time can be considered.

In the above disclosure, the average and variance are calculated on the basis of information on the behavior of one user, but there is no limitation thereto. The average and variance of information on the behavior of one user for which the target value is to be set and another user whose behavior is similar to that of the one user may be used. For example, it can be considered that another user may be a user whose attributes (such as age, sex, place of residence, or occupation) matches those of the one user, but the inclusion of other users may not be excluded.

In the target value setting device 100 of the present disclosure, the statistical information is an average value of the user's behavior over the predetermined period of time, a median value of the behavior, a mode value thereof, or a value in which a frequency of the behavior is equal to or greater than a predetermined value. In the above description, the average value has been used as an example, but naturally, there is no limitation thereto, and the median value or the like may also be used.

In addition, the statistical information further includes variance information expressing the degree of variance of the user's behavior over the predetermined period of time. For example, variance or standard deviation may be used.

By using such statistical information, it is possible to set target values for each user based on the current situation.

In addition, the target value setting device 100 of the present disclosure includes the data acquisition unit 101 that acquires behavior information (for example, the number of steps taken) of one user's behavior over a predetermined period of time. In a case where the acquired behavior information is constituted by a plurality of distributions, the target value calculation unit 103 functions as a clustering unit that performs a clustering process on the behavior information. The target value calculation unit 103 sets a target value for the one user's behavior for each of a plurality of pieces of clustered behavior information. Meanwhile, a target value may be set for at least one piece of behavior information.

The target value calculation unit 103 clusters the behavior information (for example, the number of steps taken) for each situation on the basis of the feature amounts which are specified situations (such as, for example, day of the week, weather, or time slot).

According to such a configuration, it is possible to decompose user behavior on the basis of the situation distributions which are several feature amounts, and to ascertain which behaviors at what timing constitute each distribution. For example, it is possible to ascertain that user behavior changes depending on the day of the week, or that user behavior changes depending on the weather.

The target value calculation unit 103 clusters the behavior information on the basis of a feature amount which is one specified situation (for example, a time slot), and determines whether the clustering has been performed while satisfying a predetermined condition on the basis of index information relating to the clustering (for example, an information criterion such as an AIC) when performing the clustering. The calculation unit clusters the user's behavior information (the number of steps taken) by further adding the feature amount of another situation when it is determined that the predetermined condition is not satisfied.

According to such a configuration, the validity of the clustering result can be determined by a predetermined index such as an information criterion. Thus, the user's behavior can be more appropriately ascertained by repeating the clustering with additional views of the situation (feature amount) until the index determines that the clustering is valid.

The target value calculation unit 103 of the present disclosure may perform clustering using each of a plurality of specified situations (feature amounts) to obtain a plurality of clustering results (a plurality of distributions), and adopt behavior information indicated by a clustering result that satisfies a predetermined condition from the clustering results (distributions).

That is, the target value calculation unit 103 generates a distribution of user behavior in several clustering patterns. The predetermined condition here is an information criterion, and behavior information having a distribution clustered in a more appropriate clustering pattern on the basis of the information criterion may be adopted. In the above disclosure, the feature amounts are added in order, but they may be clustered in advance into all patterns or a plurality of patterns using predetermined feature amounts.

The target value calculation unit 103 of the present disclosure deals with the day of the week, date, weather, amount of rainfall, or temperature as feature amounts (situations) and performs clustering using these feature amounts. These feature amounts (situations) are considered to influence the behavior of the user.

In addition, the target value calculation unit 103 may determine whether the target value is within a range determined in advance, and correct the target value so as to be within the range in a case where the target value is not within the range determined in advance.

The target value setting device of the present disclosure has the following configuration.

A target value setting device comprising:
a statistical information calculation unit configured to calculate statistical information on behavior of one user and/or another user over a predetermined period of time;
a target value calculation unit configured to calculate a target value of the behavior of the one user on the basis of the statistical information; and
a notification unit configured to notify the one user of the target value,
wherein the target value is set on the basis of the statistical information so that a load is higher than normal behavior of the one user or healthier than normal.

The target value setting device according to [1], wherein the statistical information is an average value of the behavior over the predetermined period of time, a median value of the behavior, a mode value thereof, or a value in which a frequency of the behavior is equal to or greater than a predetermined value.

The target value setting device according to [2], wherein the statistical information further includes variance information expressing a degree of variance of the behavior over the predetermined period of time.

The target value setting device according to any one of [1] to [3], further comprising:
a behavior information acquisition unit configured to acquire behavior information on behavior of the one user or/and the other user over a predetermined period of time; and
a clustering unit configured to perform a clustering process on the behavior information in a case where the behavior information is constituted by a plurality of distributions,
wherein the target value calculation unit sets a target value for the behavior of the one user for each of the plurality of pieces of clustered behavior information.

The target value setting device according to [4], wherein the clustering unit clusters the behavior information on the basis of a specified situation.

The target value setting device according to [5], wherein the clustering unit
clusters the behavior information on the basis of one specified situation,
determines whether the clustering has been performed while satisfying a predetermined condition on the basis of index information relating to the clustering when performing the clustering, and
clusters the behavior information by further adding another situation or replacing the one situation with another situation when it is determined that predetermined condition is not satisfied.

The target value setting device according to [5], wherein the clustering unit
performs clustering using each of a plurality of specified situations to obtain a plurality of clustering results, and
adopts behavior information indicated by a clustering result that satisfies a predetermined condition from the clustering results.

The target value setting device according to [5] or [6], wherein the situation is a day of the week, a date, weather, an amount of rainfall or, a temperature.

The target value setting device according to any one of [1] to [8], further comprising:
an appropriateness determination unit configured to determine whether the target value is within a range determined in advance; and
a correction unit configured to update the target value so as to be within the range in a case where the target value is not within the range determined in advance.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

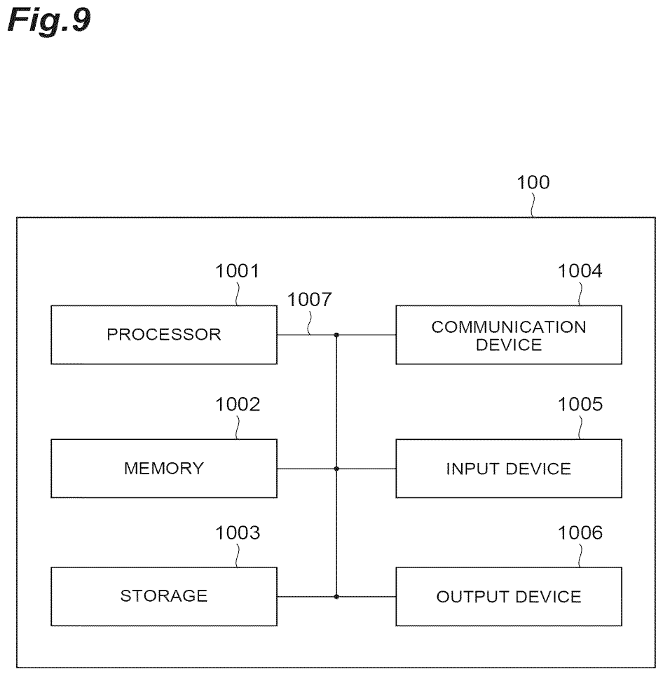

For example, the target value setting device 100 according to one embodiment of the present disclosure may function as a computer that performs processing of a target value setting method according to the present disclosure. FIG. 9 is a view showing an example of the hardware configuration of the target value setting device 100 according to one embodiment of the present disclosure. The target value setting device 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the target value setting device 100 may be configured to include one or a plurality of the devices shown in the drawings or may be configured without including some of those devices.

The functions of the target value setting device 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the target value calculation unit 103 described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the target value calculation unit 103 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (Erasable Programmable ROM), EEPROM (Electrically Erasable Programmable ROM), RAM (Random Access Memory) and the like, for example. The memory 1002 may be also called a register, a cache, a main memory (main storage device) or the like. The memory 1002 can store a program (program code), a software module and the like that can be executed for implementing a target value setting method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described data acquisition unit 101 and result notification unit 104 may be implemented by the communication device 1004. The data acquisition unit 101 and result notification unit 104 may be implemented in such a way that a transmitting unit and a receiving unit are physically or logically separated, or they may be integrated into a single configuration.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the target value setting device 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering”and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of”and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

20 Input device
30 Measurement device
100 Target value setting device
101 Data acquisition unit
102 Data storage unit
103 Target value calculation unit
104 Result notification unit

1. A target value setting device comprising:
a statistical information calculation unit configured to calculate statistical information on behavior of one user and/or another user over a predetermined period of time;
a target value calculation unit configured to calculate a target value of the behavior of the one user on the basis of the statistical information; and
a notification unit configured to notify the one user of the target value,
wherein the target value is set on the basis of the statistical information so that a load is higher than normal behavior of the one user or healthier than normal.

2. The target value setting device according to claim 1, wherein the statistical information is an average value of the behavior over the predetermined period of time, a median value of the behavior, a mode value thereof, or a value in which a frequency of the behavior is equal to or greater than a predetermined value.

3. The target value setting device according to claim 2, wherein the statistical information further includes variance information expressing a degree of variance of the behavior over the predetermined period of time.

4. The target value setting device according to claim 1, further comprising:
a behavior information acquisition unit configured to acquire behavior information on behavior of the one user or/and the other user over a predetermined period of time; and
a clustering unit configured to perform a clustering process on the behavior information in a case where the behavior information is constituted by a plurality of distributions,
wherein the target value calculation unit sets a target value for the behavior of the one user for each of the plurality of pieces of clustered behavior information.

5. The target value setting device according to claim 4, wherein the clustering unit clusters the behavior information on the basis of a specified situation.

6. The target value setting device according to claim 5, wherein the clustering unit
clusters the behavior information on the basis of one specified situation,
determines whether the clustering has been performed while satisfying a predetermined condition on the basis of index information relating to the clustering when performing the clustering, and
clusters the behavior information by further adding another situation or replacing the one situation with another situation when it is determined that predetermined condition is not satisfied.

7. The target value setting device according to claim 5, wherein the clustering unit
performs clustering using each of a plurality of specified situations to obtain a plurality of clustering results, and
adopts behavior information indicated by a clustering result that satisfies a predetermined condition from the clustering results.

8. The target value setting device according to claim 5, wherein the situation is a day of the week, a date, weather, an amount of rainfall or, a temperature.

9. The target value setting device according to claim 1, further comprising:
an appropriateness determination unit configured to determine whether the target value is within a range determined in advance; and
a correction unit configured to update the target value so as to be within the range in a case where the target value is not within the range determined in advance.
